(19) United States
(12) Patent Application Publication
(10) Pub. No.: US 2010/0251227 A1
(43) Pub. Date: Sep. 30, 2010

(54) BINARY RESOURCE FORMAT AND COMPILER

(75) Inventors: Athapan Arayasantiparb, Redmond, WA (US); Anatoliy Burukhin, Redmond, WA (US); Eric M. Borzello, Redmond, WA (US); Robert C. Redlich, Redmond, WA (US); Amit Kumar Ghosh, Redmond, WA (US); Voraluk Tosukhowong, Redmond, WA (US); Mohamed Reda Elkhadiri, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/410,472

(22) Filed: Mar. 25, 2009

(51) Int. Cl. G06F 9/45

(52) U.S. Cl. 717/151

(57) ABSTRACT

Optimization architecture for applications that uses a localization model in which localizable resources are separated from code. The resources are typically located in separate DLL files as binary blobs in a unique format. The format is designed for optimized performance and to accommodate various requirements of complex office applications. The binary blobs are produced by a resource compiler based on the format. The architecture includes a resource binary format that facilitates resource identification and lookup, optimization of memory paging by grouping and ordering resources according to runtime use, optimization by compressing resources with an optimal algorithm that is fast in decompression, fast reverse lookup of a resource identifier by resource content, resource grouping, resource substitution, branding, and resource runtime metadata (also referred to as user data).

### BACKGROUND

Software products and applications typically incorporate a variety of different textual labels and other types of string data, referred to herein generally as types of resource. Typically, resources are stored and maintained in a variety of disparate formats. These resources may be localized so that the software products and applications can be marketed globally to users that speak a variety of different languages. However, if these resources to be localized are stored and maintained in a variety of different formats, these multiple formats can complicate the localization process.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Disclosed is an optimization architecture for office suite applications, for example, that uses a localization model in which localizable resources are separated from code. The resources are typically located in separate DLL (dynamic-link library) files (or other shared resources) as binary blobs in a unique format. The format is designed for optimized performance and to accommodate various requirements of complex office applications. The binary blobs are produced by a resource compiler that has numerous features.

The architecture is a computer-implemented data processing system comprising a format component for representing resources of multiple different data structures in a format for optimized use by a specified application, and a compiler for transforming the format of resources into a runtime for optimized access to the resources by the application. The architecture includes a resource binary format, resource identification and lookup model, facilitates optimization of memory paging by grouping and ordering resources according to runtime use, optimization by compressing resources with an optimal algorithm that is fast in decompression, fast reverse lookup of a resource identifier by resource content, resource grouping, resource substitution, branding, and resource runtime metadata (also referred to as user data).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented data processing system in accordance with the disclosed architecture.

FIG. 2 illustrates a system that utilizes a logging component for logging loading operations of the application for determining optimum ordering of localized resources for runtime use by the application.

FIG. 3 illustrates a computer-implemented data processing method.

FIG. 4 illustrates additional aspects of the method of FIG. 3.

FIG. 5 illustrates additional aspects of the method of FIG. 3.

FIG. 6 illustrates a block diagram of a computing system operable to execute formatting and compiling resource information of resources for optimized utilization by related applications, in accordance with the disclosed architecture.

### DETAILED DESCRIPTION

During application startup, for example, the application can call an API many times at boot, UI drawing, and document reading, with most if not all of these operations having associated resources to load. The amount of resources can affect application runtime performance.

To that end, the disclosed architecture provides an efficient binary format, fast API and intelligent compiler. Performance features include resource layout in a binary blob, as well as algorithms for indexing, compression, and encoding. This reduces page faults, cycles, and memory usage for all API functions.

Reading resources from a file is a performance related task. Thus, efficient layout and indexing, as provided herein, significantly improves performance results. According to the disclosed binary format, string resources, for example, are not grouped in predefined tables. The table-free approach allows providing data in the order of loading. For example, all boot strings (or other resources) can fit into a few contiguous pages. Additionally, identifiers (IDs) are the indexes (an ID is an index in the array of string offsets). Indexes are close to the data, such as in the same page. Compression is provided that is “hit-free” in that if compression is determined to impact performance, compression is not performed; otherwise, compression is employed.

The optimization offered by ordered resource loading utilizes knowledge of application runtime resource loading order. Moreover, the offsets and strings are restructured in small tables that fit in one page, where the tables created by the resource compiler and sized for better performance. It is to be appreciated that the disclosed architecture is not limited to string resources, but applies to all types of resources used by an application.

The architecture includes a resource binary format, resource identification and lookup model, facilitates optimization of memory paging by grouping and ordering resources according to runtime use, optimization by compressing resources with an optimal algorithm that is fast in decompression, fast reverse lookup of a resource identifier by resource content, resource grouping, resource substitution, branding, and resource runtime metadata (also referred to as user data).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

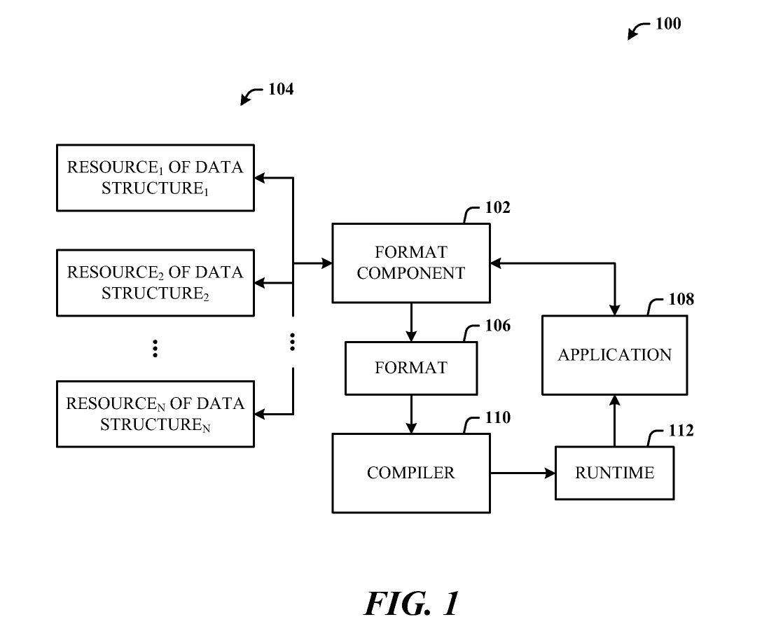

FIG. 1 illustrates a computer-implemented data processing system 100 in accordance with the disclosed architecture. The system 100 includes a format component 102 for representing resources 104 of multiple different data structures in a format 106 for optimized use by a specified application 108, and a compiler 110 for transforming the format 106 of resources into a runtime 112 for optimized access to the resources by the application 108.

The format 106 can be structured to represent objects and strings as XML (extensible markup language) entries. Additionally, the format component 102 includes an element that facilitates access to the resources 104 in resource groups defined as a string table. The format component 102 also includes an element that specifies the substitution of one resource for another resource. The format component 102 also includes an element that specifies the maintaining of shared resources in a central location. The format component 102 further includes an element that specifies the storage of extra data (e.g., user data) of the resources 104 in the runtime 112. The resources 104 can be assigned identifiers, and lookup of a resource is based on at least one of the identifiers.

The compiler 110 can optimize memory paging by grouping and ordering the resources 104 according to runtime use. In other words, there can be many different application interfaces (APIs) that access the localized resources in different ways (ordering) and for different purposes. One optimization includes the compiler 110 compressing the format 106 during compile using an optimization algorithm. The compression/decompression algorithm is selected for optimum compression and decompression performance in view of the application processing. For example, if compression impedes application performance, compression can be waived for that particular runtime. Other aspects are described in detail herein.

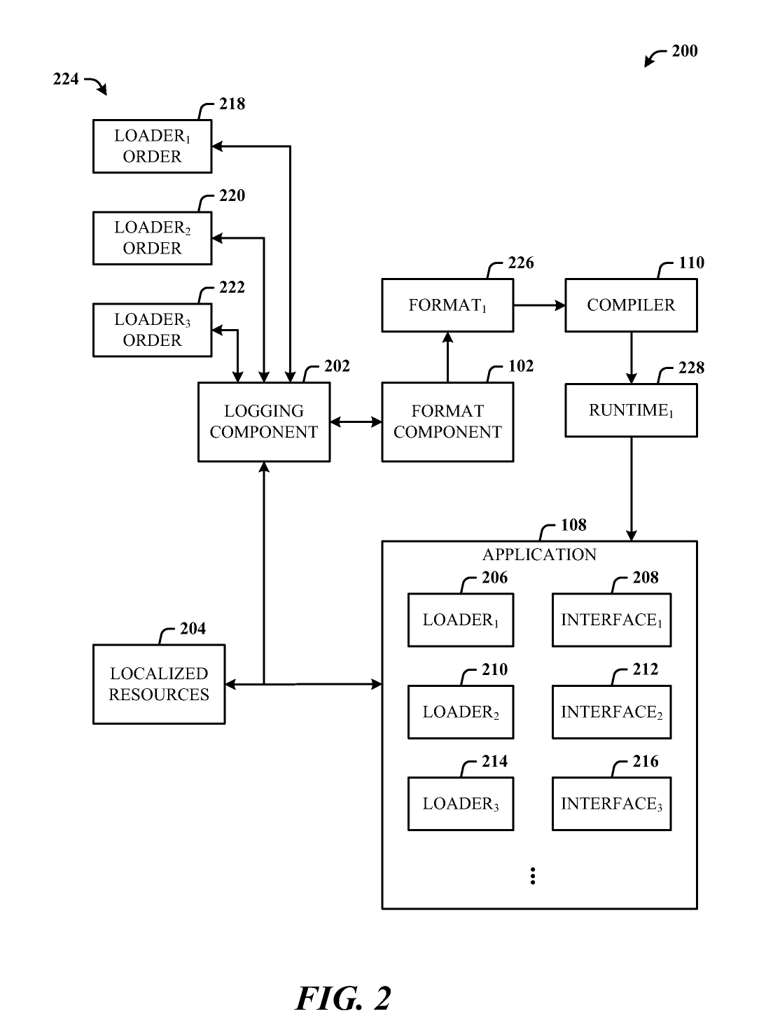

FIG. 2 illustrates a system 200 that utilizes a logging component 202 for logging loading operations of the application 108 for determining optimum ordering of localized resources 204 (e.g., resources 104 of FIG. 1) for runtime use by the application 108. The application 108 can include many different interfaces and associated loaders, such as a first loader 206 for a first interface 208, a second loader 210 for a second interface 212, a third loader 214 for a third interface 216, and so on. When the first interface 208 seeks access to one or more of the localized resources 204, the first loader 206 executes requests for the requested resources in an ordered manner. The logging component 202 logs (tracks) this requested order, and stores first loader order information 218.

Similarly, when the second interface 212 seeks access to one or more of the localized resources 204, the second loader 210 executes requests for the requested resources in an ordered manner, in response to which the logging component 202 logs (tracks) this requested order, and stores second loader order information 220. Still further, when the third interface 216 seeks access to one or more of the localized resources 204, the third loader 214 executes requests for the requested resources in an ordered manner, in response to which the logging component 202 logs (tracks) this requested order, and stores third loader order information 222.

The format component 102 can access the loader order information 224 as needed during the formatting process to generate a desired format for the particular purpose of the application interface. For example, a first format 226 is compiled by the compiler 110 into a first runtime 228 for specific use by the application 108 such as the first interface 208. The compiled format in a binary format (the first runtime 228) can then be utilized to access for the localized resources 204 in a performant way by the first interface 208 of the application 108.

Put another way, the system 200 is a computer-implemented data processing system that comprises the format component 102 for representing localized resources 204 of multiple different data structures in a format of resource information that is ordered for optimized performance of the related application, and the compiler 110 for compiling the format into a runtime binary for execution by the application 108 for performant access of the resources. The resources are assigned identifiers and lookup of a resource is based on at least one of the identifiers or a reverse lookup of a resource ID is performed based on resource content. The compiler 110 optimizes memory paging by grouping and ordering the resources according to runtime use. The logging component 202 logs (tracks) the order in which the application 108 loads the resources, and the format component 102 represents the resource information in the format according to the logged order.

Following is a more detailed description of the disclosed binary resource format. The binary resource format is a compressed and optimized binary representation of resources (e.g., strings) authored in a base format. The base format is an XML-based resource file format that includes XML entries which specify objects and strings, for example, inside XML tags. The base format file can be opened with a text editor, written to, parsed, and manipulated. The base format is also conducive for authoring, but is unsuitable for runtime because of text-based formats. In the base format, resources are stored in triplets Name-Value-Comment. In addition, there are also <meta> elements to store any other types of information, such as localization instructions. The base format also allows recursive nesting of the triplets.

Following is an example of a string group (string table) that includes a string resource with metadata:

```
<data name=“sttMessages” type=“mso:resources”>
    <data name=“idsPageNotFound”>
        <value> The page you're trying to reach could not be
found. </value>
        <comment>404 err</comment>
        <meta name=“locver”>
            <value>{StringCategory=“Error Message”}</value>
        </meta>
    </data>
... more strings
</data>
```

There are three kinds of resource identifiers. A “name” identifier is assigned by a resource author. In the above example, the name is “idsPageNotFound”. The name identifier has a string type (or resource type) in code. A second resource identifier is a generated ID. These IDs are generated by the resource compiler. The resource compiler processes the base files and generates several output files, one of which is a header file where IDs are defined as in the following example.
#define idsPageNotFound 0x00000001

A third resource identifier is an assigned ID. The resource author can assign an explicit ID or set a starting ID for a resource group. Lookup by generated ID is one way of querying resources. However, application code can require querying by name or by assigned ID. The name and assigned IDs are identifiers that change infrequently during a resource lifetime.

Features of the resource compiler include map data, ID map, Condition, substitution, branding, ignore table, user data, start ID for the binary resource, header setting, and unquote.

The binary resource format blob is generated by the resource compiler, which is an internal tool. This is described in greater detail hereinafter.

Following are definitions that will be employed in the description. External ID: all resources within a binary resource format are referred to externally by a Dword ID. Internal ID: all elements within a binary resource format are found internally by an Internal ID. Oftentimes, the internal IDs are exactly the same as the external IDs. However, sometimes internal IDs are a translation from the external IDs. In this case, an internal translation can be performed. Token identifier: generally, resources are referred to externally by an IDS_Token_Identifier. This token directly corresponds to an External ID. User data: a blob of data from the user. The user can put anything desired here and nothing will be assumed about it.

A trie is a common tree data structure, used to look up an Internal ID from a string. The trie includes a trie header and trie node. The header can include fields that hold information related to the number of trie nodes, character size in each node, bits in a node left/right index, bits in a node, total bytes of all nodes, and a sequential set of the nodes.

The trie node can includes fields that hold information related to a left node offset, right node offset, as well as the internal ID this trie element points to. An exemplary trie lookup algorithm can be as follows:

```
pwz = pointer to null terminated wchar string
node = node pointer
uiCurrentNode = integer which refers to a node in TrieNodes[ ]
GetRight(int currentNode) returns the integer index in
TrieNodes[ ] of TrieNodes[currentNode]’s right node
GetLeft(int currentNode) returns the integer index in
TrieNodes[ ] of TrieNodes[currentNode]’s left node
uiCurrentNode = 0;
while(true){
    node = TrieNodes[uiCurrentNode];
    if (*pwz == node.wData)
        {
        pwz++;
        if (*pwz == NULL)
            {
            break;
            }
        uiCurrentNode = GetRight(uiCurrentNode);
        }
    else
        uiCurrentNode = GetLeft(uiCurrentNode);
    if (uiCurrentNode == 0)
        break;
    }
}
```

The file layout multi-use piece includes a CPS block, which further includes the majority of the binary resource data, as well as headers for resource clusters, table clusters, and user data clusters. A binID block includes a conversion table from token IDs to internal IDs. A provided CTB (cipher type byte) block is a compression block.

The CPS block includes fields that hold information related to the first internal ID, the number of internal IDs, quick lookup blob, table information blob, resource and table clusters blob, ID map blob, user data blob, and user data trie.

The quick lookup is for pointing a single internal ID to a resource cluster located elsewhere. A quick lookup element is a single element that provides the offset from the beginning of the resource and tables cluster to the resource cluster in which the resource is contained.

Table Info contains information about the transition from an external ID to a table cluster. The table info blob includes an array of the different table in this file. TableInfo is a single element that tracks the number of elements in the table, external ID of the first element in the table, size of the table, and an offset from the beginning of the resource and clusters to the individual table cluster. TableType is an enumeration of the four table types: resource, fixed, allocated and list.

A resource table is a base format table type holding resources that applications access by ID only. A fixed table is a base format table type for holding resources with fixed numerical IDs. An allocated table is a base format table type holding resources that applications access by ID or index. A list table is a base format table type holding ID-less resources that applications access by index only.

The Resource and Table Cluster Blob includes all the resource clusters and table clusters. The Resource Cluster is a collection of resources. The Resource Cluster includes the cluster header and end data marker (an index resource that points to the data position immediately after the last position in the cluster header for determining the length of the last string in this resource cluster), and the sequential binary data referenced by the cluster header.

IndexResource is a single element that includes information related to uncompressed data, user data, compression table for compressing this string, and offset from the beginning if the resource cluster to the resource indexed by this index.

The Table Cluster includes all the data for a single table. This also includes compression status, references to strings that are further away, and the actual strings in this table.

The ID Map is for User ID Map Data that locates external IDs if different from internal IDs. The map data includes the consecutive array of ranges and nodes used to map single user IDs to the internal IDs. The array of node ranges map ranges of external IDs to internal IDs. The array of nodes maps an external ID to an internal ID.

The User Data Blob includes the user data. The User Data Trie is for the lookup of IDs from tokens for user data. The binID block includes lookup data for elements in Tables Clusters and Resource Clusters based on name rather than numeric ID. The CTB block is related to compression tables and includes a decompression table count. Decompression Table is a single element that includes information such as decompression table size, type, and strings in the table, for example.

Following is a detailed description of the compiler. The compiler combines one or more base format files in a single based format file, creates binary representations of the resources present in the base format file (as well as a header file for mapping resources names and IDs), creates a compression table used for compressing and decompressing resources in a binary resource format file, creates a base format file where numerical and strings IDs of resources are merged from resources names, and inserts a binary format file into a new or existing DLL. Arguments passed to the compiler respect a certain order, or the compiler may fail.

A Map Data compiler feature allows users to use a map file to arrange the resource order in the binary format. Map data is a list of resource names. Resources that loaded together or almost at the same time are placed close to each other. As a result, performance is increased. The compiler puts the resources based on the order of appearance in the map data.

An ID Map compiler feature allows users to specify their own IDs for resources in a map file. Normally, the compiler generates the IDs for resources.

A Condition compiler feature allows users to control which data elements in the base format to include in the binary format or act on if combined with other features, such as substitution.

A Substitution compiler feature allows users to replace value and meta of one element with those of another element. Two kinds of elements are substitution source and substitution target. Substitution source is a data element with one or more meta elements of type “substitution”, and substitution target is a data element that the name attribute value of substitution meta refers to.

A Branding meta element allows users to keep shared resources in a central location. This means users maintain only one copy of shared resources such as product name. The shared resources can be referred by names. At compile time, the compiler replaces the shared resource names with shared resource values.

An Ignore Table compiler feature allows the user to indicate that no tables are desired in the binary format.

A User Data compiler feature is a meta element that allows users to store extra data of resources to the binary format. The compiler uses add-in binaries for this job.

Other compiler features can include a feature that allows the user to use a map file to define the starting ID to be something else. A Header Setting feature employs a settings file is to make it easy to pass in build instructions that do not change much from build to build. The settings file includes settings for how to build the binary format file. Some build instructions can be very complex and lead to large, unreadable command lines. For example, splitting the defines for various strings across various headers and only including the bare minimum of headers can reduce build time by making incremental builds more efficient. However, specifying that much data on the command line is difficult to do and even more difficult to read.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

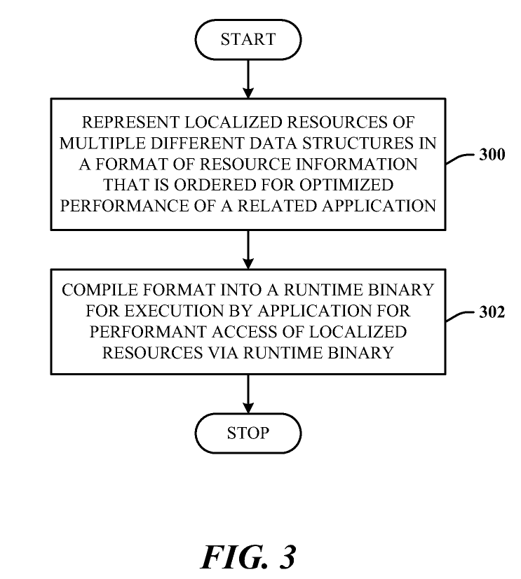

FIG. 3 illustrates a computer-implemented data processing method. At 300, localized resources of multiple different data structures are represented in a format of resource information that is ordered for optimized performance of a related application. At 302, the format is compiled into a runtime binary for execution by the application for performant access of the localized resources via the runtime binary.

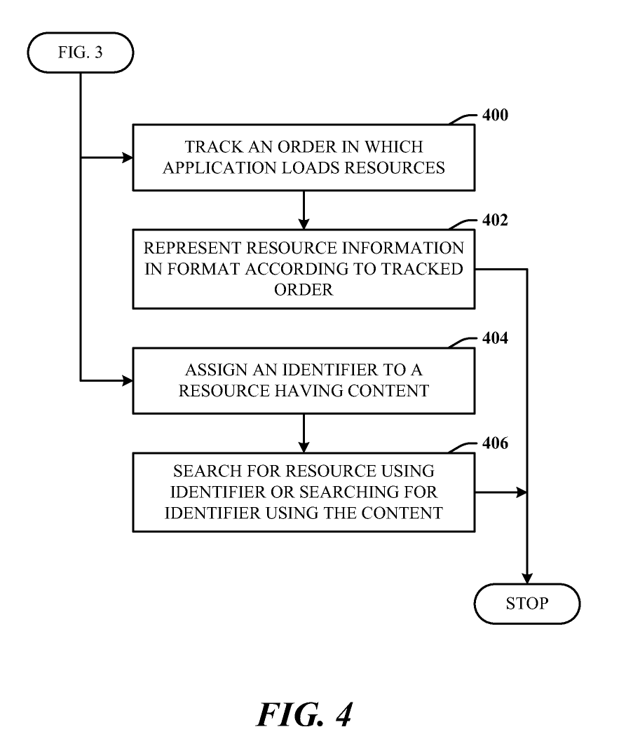

FIG. 4 illustrates additional aspects of the method of FIG. 3. At 400, an order is tracked in which the application loads the resources. At 402, the resource information in the format is represented according to the tracked order. At 404, an identifier is assigned to a resource having content. At 406, the resource is searched using the identifier or searching for the identifier using the content.

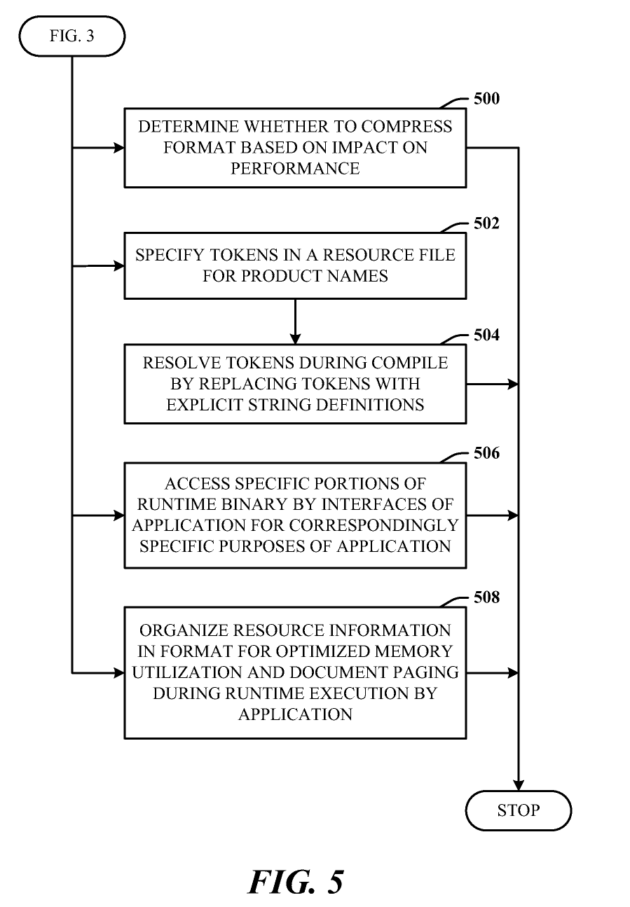

FIG. 5 illustrates additional aspects of the method of FIG. 3. At 500, a determination is made as to whether to compress the format based on impact on the performance. At 502, tokens are specified in a resource file for product names. At 504, the tokens are resolved during compile by replacing the tokens with explicit string definitions. At 506, specific portions of the runtime binary are accessed by interfaces of the application for correspondingly specific purposes of the application. At 508, the resource information is organized in the format for optimized memory utilization and document paging during runtime execution by the application.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

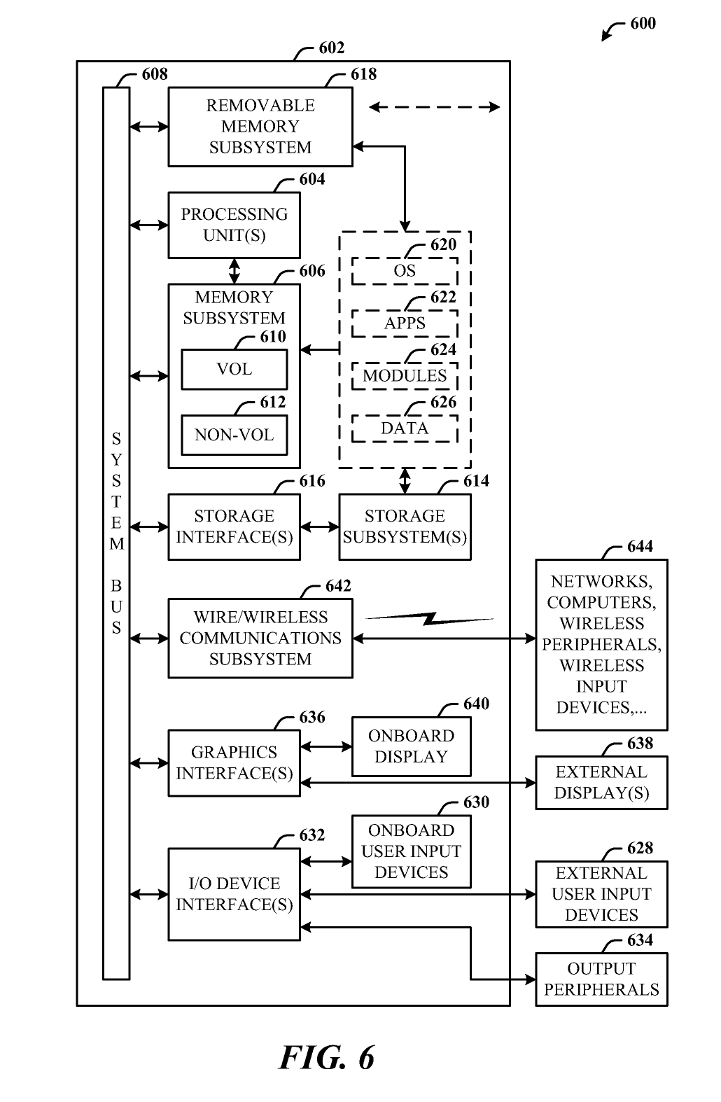

Referring now to FIG. 6, there is illustrated a block diagram of a computing system 600 operable to execute formatting and compiling resource information of resources for optimized utilization by related applications, in accordance with the disclosed architecture. In order to provide additional context for various aspects thereof, FIG. 6 and the following discussion are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604, a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 606 can include volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the memory subsystem 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes storage subsystem(s) 614 and storage interface(s) 616 for interfacing the storage subsystem(s) 614 to the system bus 608 and other desired computer components. The storage subsystem(s) 614 can include one or more of a hard disk drive (HDD), a magnetic floppy disk drive (FDD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The one or more application programs 622, other program modules 624, and program data 626 can include the entities and components of the system 100 of FIG. 1, the entities and components of the system 200 of FIG. 2, and the methods represented by the flow charts of FIGS. 3-5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Computer readable media can be any available media that can be accessed by the computer 602 and includes volatile and non-volatile media, removable and non-removable media. For the computer 602, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 602, programs, and data using external user input devices 628 such as a keyboard and a mouse. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example. These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP) using logical connections via a wired/wireless communications subsystem 642 to one or more networks and/or other computers. The other computers can include workstations, servers, routers, personal computers, microprocessor-based entertainment appliance, a peer device or other common network node, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or has other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented data processing system, comprising:
a format component for representing resources of multiple different data structures in a format for optimized use by a specified application; and
a compiler for transforming the format of resources into a runtime for optimized access to the resources by the application.

2. The system of claim 1, wherein the format is structured to represent objects and strings as XML entries.

3. The system of claim 1, wherein the format component includes an element that facilitates access to the resources in resource groups defined as a string table.

4. The system of claim 1, wherein the format component includes an element that specifies substitution of one resource for another resource.

5. The system of claim 1, wherein the format component includes an element that specifies maintaining of shared resources in a central location.

6. The system of claim 1, wherein the format component includes an element that specifies storage of extra data of resources in the runtime.

7. The system of claim 1, wherein the resources are assigned identifiers, and lookup of a resource is based on at least one of the identifiers.

8. The system of claim 1, wherein the compiler optimizes memory paging by grouping and ordering the resources according to runtime use.

9. The system of claim 1, wherein the compiler compresses the format using an optimization algorithm.

10. A computer-implemented data processing system, comprising:
a format component for representing resources of multiple different data structures in a format of resource information that is ordered for optimized performance of a related application; and
a compiler for compiling the format into a runtime binary for execution by the application for performant access of the resources.

11. The system of claim 10, wherein the resources are assigned identifiers and lookup of a resource is based on at least one of the identifiers or a reverse lookup of a resource ID is performed based on resource content.

12. The system of claim 10, wherein the compiler optimizes memory paging by grouping and ordering the resources according to runtime use.

13. The system of claim 10, further comprising a logging component for logging an order in which the application loads the resources, the format component represents the resource information in the format according to the logged order.

14. A computer-implemented data processing method, comprising:
representing localized resources of multiple different data structures in a format of resource information that is ordered for optimized performance of a related application; and
compiling the format into a runtime binary for execution by the application for performant access of the localized resources via the runtime binary.

15. The method of claim 14, further comprising:
tracking an order in which the application loads the resources; and
representing the resource information in the format according to the tracked order.

16. The method of claim 14, further comprising:
assigning an identifier to a resource having content; and
searching for the resource using the identifier or searching for the identifier using the content.

17. The method of claim 14, further comprising determining whether to compress the format based on impact on the performance.

18. The method of claim 14, further comprising;
specifying tokens in a resource file for product names; and
resolving the tokens during compile by replacing the tokens with explicit string definitions.

19. The method of claim 14, further comprising accessing specific portions of the runtime binary by interfaces of the application for correspondingly specific purposes of the application.

20. The method of claim 14, further comprising organizing the resource information in the format for optimized memory utilization and document paging during runtime execution by the application.
